(19) United States
(12) Patent Application Publication
(10) Pub. No.: US 2026/0154632 A1
(43) Pub. Date: Jun. 4, 2026

(54) SYSTEM

(71) Applicant: SOFTBANK GROUP CORP., Tokyo (JP)

(72) Inventor: Tomohiro UMENO, Tokyo (JP)

(73) Assignee: SOFTBANK GROUP CORP., Tokyo (JP)

(21) Appl. No.: 19/357,144

(22) Filed: Oct. 14, 2025

(30) Foreign Application Priority Data
Oct. 18, 2024 (JP) 2024-183721

(51) Int. Cl. G06Q 10/0631

(52) U.S. Cl. CPC G06Q 10/063116

(57) ABSTRACT

A system includes a processor that retrieves work information and product information, generates an optimized work schedule using a generative AI, displays the generated work schedule on a user terminal, detects changes in real time and updates the work schedule.

### CROSS-REFERENCE TO RELATED APPLICATION

This application is based on and claims priority under 35 USC 119 from Japanese Patent Application No. 2024-183721 filed on Oct. 18, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In logistics operations, there are significant challenges in creating efficient work schedules that can flexibly respond to changing conditions, such as unpredictable labor attendance and variable shipment volumes. Conventional scheduling systems often lack the capability to optimize task allocation dynamically according to real-time information or to promptly update work instructions when unforeseen events occur. As a result, operational inefficiencies, delays, and resource wastage frequently arise.

### SUMMARY

To address these challenges, the present invention provides a system comprising a processor that retrieves work information and product information, generates an optimized work schedule using a generative AI, displays the generated schedule on a user terminal, and detects and updates the work schedule in real time in response to changing conditions. The processor may further predict future labor demand and supply and analyze past performance data to enhance operational efficiency.

“Work information” means that data related to individual workers, including their skills, schedules, tasks, attendance records, and other attributes necessary for operational planning.

“Product information” means that data concerning goods being handled in logistics operations, such as shipment details, arrival and departure schedules, size, type, and special handling requirements.

“Generative AI” means that an artificial intelligence system capable of producing optimized outputs, such as work schedules, by analyzing complex datasets and considering various constraints and objectives.

“Work schedule” means that a plan or timetable assigning specific tasks to workers within a given timeframe, optimized for operational efficiency.

“User terminal” means that an electronic device operated by a user, such as a computer, tablet, or smartphone, used to display schedules and receive notifications from the system.

“Real time” means that processing or actions occur instantaneously or with minimal delay as events unfold, enabling immediate responsiveness to changes and new information.

“Changes” means that modifications in the logistical environment or operational conditions, including worker attendance, shipment updates, and unforeseen disruptions, which affect planned schedules.

“Update” means that a process by which the system revises and adjusts the work schedule in response to detected changes, ensuring continual optimization.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

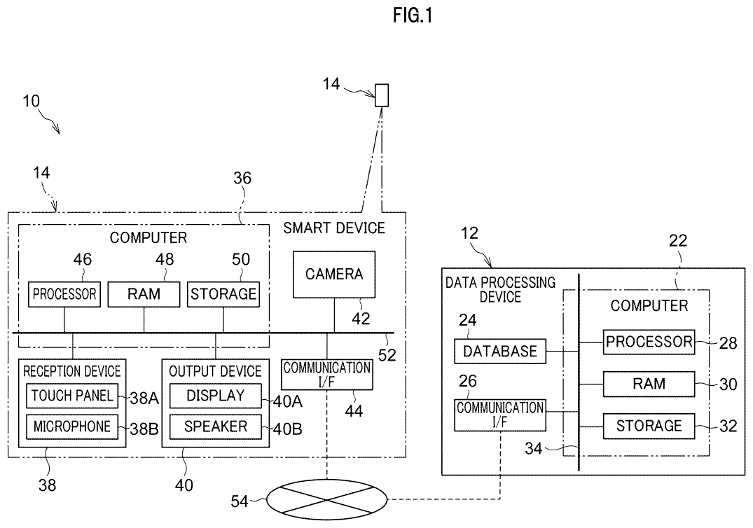

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

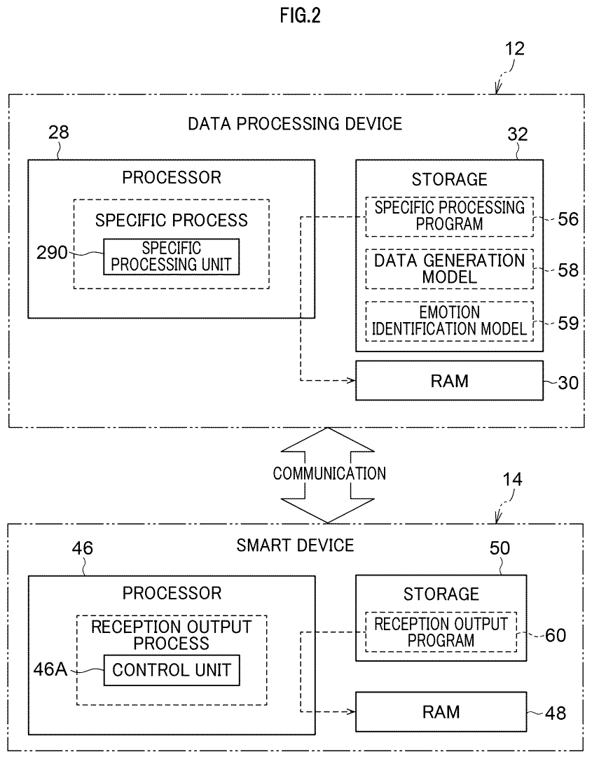

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In modern logistics operations, there is a growing need for efficient schedule management and real-time adaptation to changes in the field. Frequent revisions of operation plans in response to fluctuations in task information and item information must be performed both promptly and accurately. Furthermore, ensuring optimal allocation of personnel based on individual skills and characteristics is critical to improving overall operational efficiency. Existing methods often require manual verification of data consistency and manual generation and updating of detailed schedules, which makes timely response and optimization difficult. There is thus a need for a system that can automatically collect, validate, and process relevant data and provide optimized operation schedules in real time.

The specific processing by the specific processing unit 290 of the data processing device 12 in Example 1 is realized by the following means.

The present invention provides a server comprising a processor configured to collect operation-related information and item-related information from an information storage device, perform integrity verification and data cleansing, dynamically generate a prompt sentence for input to a generative artificial intelligence model, automatically generate an optimized operation schedule, output the generated operation schedule information to an information display device, and monitor real-time status changes to update the operation schedule by resubmitting a prompt sentence to the generative artificial intelligence model. This enables rapid and accurate generation and updating of optimized operation schedules, improves adaptability and efficiency in logistics operations, and minimizes the burden of manual data handling and scheduling.

The term “operation-related information” refers to data concerning individual tasks, progress status, required skills, equipment usage, and personnel assignments in operational activities.

The term “item-related information” refers to data regarding the types, quantities, storage locations, and scheduled shipment times of goods handled in operational activities.

The term “information storage device” refers to any hardware or system, such as a database server or storage medium, used to store and manage large volumes of data for retrieval, updating, and management.

The term “integrity verification” refers to the process of confirming the consistency, accuracy, and reliability of data to ensure there are no contradictions or errors among data records.

The term “data cleansing” refers to the process of correcting, removing, or updating incomplete, duplicate, or erroneous entries in a dataset to improve data quality.

The term “prompt sentence” refers to a dynamically generated instruction or query, constructed from collected and processed data, and provided as input to a generative artificial intelligence model to elicit a targeted response or solution.

The term “generative artificial intelligence model” refers to an artificial intelligence system that automatically produces new plans, predictions, or content based on analysis of large datasets and input prompts.

The term “operation schedule” refers to an organized plan or timetable that specifies the start times, assigned personnel, and sequence of tasks to be performed in an operational context.

The term “information display device” refers to an apparatus, such as a user terminal or graphical interface, configured to present operation schedules and related information in a visual or interactive format.

The term “monitoring information” refers to real-time or continuously collected data related to the status of operational environments, such as equipment states, personnel attendance, progress updates, and environmental conditions.

The term “status changes” refers to alterations or updates in operational circumstances, such as personnel absence, delays, or equipment breakdowns, that may affect planned activities.

The term “labor resources” refers to personnel or workforce available for assignment to operational activities, taking into account their skills, availability, and roles.

The term “operational performance data” refers to past records or metrics that reflect how tasks or operations were executed, including efficiency, delays, errors, and resource utilization.

One embodiment for implementing the present invention is described as follows.

The server comprises a processor, memory, and network interface hardware. As an example, the processor may be an x86 or ARM central processing unit, and the network interface is configured to support communication over TCP/IP and HTTPS protocols. The server operates using software such as a Linux operating system, a relational database management system (for example, MySQL or PostgreSQL), and a programming environment such as Python. The server further incorporates data processing libraries such as pandas for data cleansing and validation, and accesses a generative artificial intelligence model, such as a large language model platform provided by a cloud computing service or accessed via an API.

The terminal, which may take the form of a tablet computer, a desktop workstation, or a portable smart device, includes a graphical user interface application. For instance, the terminal may utilize a modern web browser or a native application built with frameworks such as React.js or Flutter. The terminal is capable of displaying interactive dashboards and receiving input from the user (for example, a logistics manager).

The user, accessing the terminal, is able to interact with the system, review suggested operation schedules, and make manual adjustments or confirmations.

To operate, the server collects operation-related information and item-related information from the database. Data may include worker profiles (such as skill levels, certifications, and availability), as well as item data (such as product types, inventory, storage locations, and shipment schedules). The server applies integrity verification using scripts (for example, Python scripts using pandas), performing duplicate elimination, completion of missing values, and correction of inconsistent records. This ensures only high-quality, cleansed data are used for subsequent processing.

Next, the server dynamically constructs a prompt sentence, in natural language, based on the cleansed data. An illustrative example of a prompt sentence is: “Generate an optimal logistics workflow for 3 warehouse workers (Worker A: forklift, Worker B: packing, Worker C: inventory) with 500 packages arriving at 10 AM, 3 shipments departing at 4 PM, and Worker C absent in the morning. Assign tasks accordingly.”

The server transmits the prompt, along with relevant data, to a generative AI model—such as a cloud-hosted large language model—via an API call over a secure network connection. The generative AI model analyzes the prompt and provided data, and automatically produces an optimized operation schedule that matches current conditions and workflow requirements. The result contains, for example, timing for each task, assignment of workers, and task sequencing.

Upon receiving the generated operation schedule, the server forwards it to the terminal. The terminal, via its user interface, displays the operation schedule as an interactive dashboard, which may include tables, Gantt charts, or other visual aids to facilitate comprehension by the user.

The user visually reviews the schedule displayed on the terminal. If necessary, the user may make manual adjustments, such as reassigning workers or altering task times, leveraging the terminal's interactive functions. After confirmation, the user can submit approval or feedback, which the terminal transmits back to the server.

Additionally, the server continuously monitors real-time information from the operational environment. The server may interface with various sensors, attendance management systems, or external logistics tracking platforms. When a status change is detected—for example, a worker's unexpected absence, a delivery delay, or equipment failure—the server creates a new prompt sentence reflecting the current situation (e.g., “Due to Worker B's sudden absence and a 30-minute delivery delay, re-optimize today's task assignments for remaining staff. Assign priorities to urgent shipments.”). The server then repeats the optimization process, ensuring the operation schedule remains current and effective.

In summary, this embodiment enables fully automated and optimized operation scheduling by leveraging data acquisition, data cleansing, dynamic prompt sentence generation, interaction with a generative AI model, real-time environment monitoring, and interactive schedule presentation. The technical advantage is the ability to adapt quickly to changes, maintain optimal operations, and reduce manual workload for users.

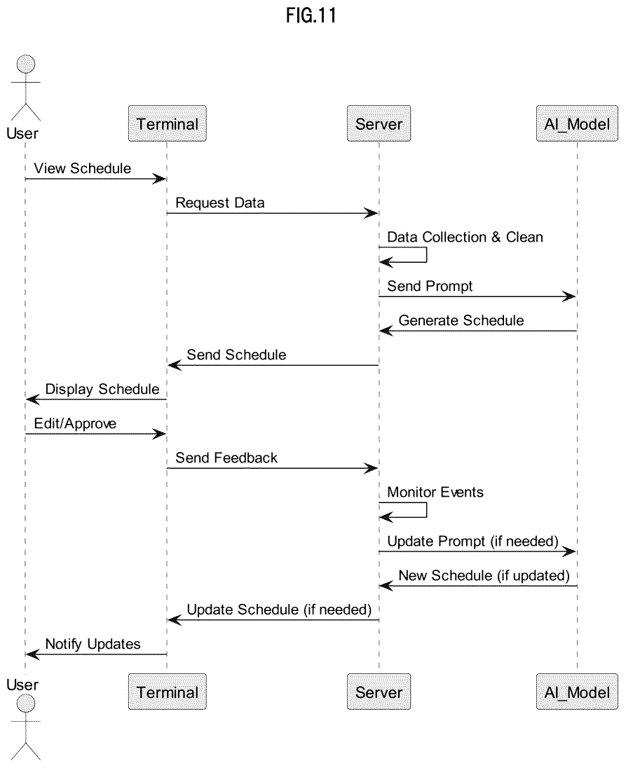

The following describes the processing flow using FIG. 11.

### Step 1

Server collects operation-related information and item-related information from an information storage device, such as a database. The input is raw data, including worker profiles (skills, availability), task lists, inventory details, and shipment schedules. Server processes the input data by executing data retrieval queries, and outputs collected data sets for further use.

### Step 2

Server performs integrity verification and data cleansing on the collected data. The input is the collected raw data from Step 1. Server uses data validation scripts and data processing libraries to identify and remove duplicate entries, correct inconsistent records, and complete missing values. The output is a cleansed, high-quality data set.

### Step 3

Server generates a prompt sentence based on the cleansed data to formulate a scheduling request. The input is the cleansed dataset from Step 2. Server dynamically constructs a natural language prompt sentence, such as, “Generate an optimal warehouse schedule for three workers (Worker A: forklift, Worker B: packing, Worker C: inventory) with 500 packages arriving at 10 AM and Worker C absent in the morning.” The output is a prompt sentence tailored to the current operational context.

### Step 4

Server transmits the prompt sentence and structured data to a generative AI model via an API call, and requests generation of an optimized operation schedule. The input is the prompt sentence along with associated data. Server sends the API request, receives from the generative AI model the output—an automatically generated operation schedule specifying task assignments, timelines, and worker allocation.

### Step 5

Server forwards the generated operation schedule to the terminal. The input is the AI-generated operation schedule. Server transmits the schedule over a secure network channel to the terminal device, where the output is a data payload formatted for visualization.

### Step 6

Terminal displays the received operation schedule on an interactive dashboard. The input is the operation schedule received from the server. Terminal renders graphical representations, such as Gantt charts or tables, so that the user can visually review the schedule. The output is an interactive display for user evaluation.

### Step 7

User reviews the displayed operation schedule using the terminal. The input is the interactive dashboard. User may make manual adjustments, such as reassigning tasks or changing times, by interacting with the user interface. The output is the confirmation or modification of the proposed schedule.

### Step 8

Terminal sends any user approval, manual changes, or feedback back to the server for recording in the system. The input is the user's confirmation or alteration. Terminal transmits the updated information, and the output is updated operation parameters within the server database.

### Step 9

Server continuously monitors real-time status and environment changes via inputs from sensors, attendance systems, or external management systems. The input is real-time event data, such as worker absences or shipment delays. Server detects any change in status and, when necessary, returns to Step 3 to generate a new prompt sentence and initiates the rescheduling process. The output is a revised, up-to-date operation schedule.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In logistics operations and other complex task environments, efficient and flexible scheduling is essential for maximizing productivity and adapting to real-time changes. However, conventional systems often lack the ability to rapidly generate optimal schedules tailored to each worker's skill, current workload, or sudden changes in product flow, and cannot adaptively adjust task allocation based on user emotion or feedback. This leads to reduced operational efficiency, increased worker stress, and delayed responses to unexpected events at worksites.

The specific processing by the specific processing unit 290 of the data processing device 12 in Application Example 1 is realized by the following means.

The present invention provides a server comprising a processor configured to acquire worker attribute information, task history information, and item attribute information, perform data consistency checking and pre-processing, generate a prompt sentence for a generative artificial intelligence model to automatically generate an optimized work schedule, display the work schedule interactively on a mobile information terminal equipped with a visual display device, acquire change information in real time to dynamically update the schedule, estimate user emotional state, adaptively adjust the assignment or display method based on emotion estimation, and acquire and utilize feedback information from work progress or user operations. This enables efficient, responsive, and user-adaptive scheduling while supporting real-time updates and consideration of worker wellbeing, leading to highly productive and flexible task operations.

The term “worker attribute information” refers to data relating to individual workers, including their skills, qualifications, roles, work experience, schedules, and any other characteristics that may affect task assignment in operations.

The term “task history information” refers to records of tasks previously performed by workers, including details of task types, completion times, outcomes, and performance metrics.

The term “item attribute information” refers to information describing items or goods handled during operations, such as item identification numbers, types, physical properties, quantities, locations, and logistical statuses.

The term “data consistency checking” refers to the process of verifying the completeness, correctness, and compatibility of multiple sets of data to ensure accuracy and reliable integration.

The term “pre-processing” refers to the preparation of data prior to input into computational models, including cleaning, formatting, normalization, and structuring of data.

The term “prompt sentence” refers to a structured input, typically a command or query, generated from data and sent to a generative artificial intelligence model to guide output generation.

The term “generative artificial intelligence model” refers to a computational model or algorithm capable of receiving data inputs and producing schedules or other solutions by synthesizing and optimizing information using machine learning or deep learning techniques.

The term “optimized work schedule” refers to a set of task assignments and timings for workers that maximize efficiency, productivity, or other specified criteria, taking into account constraints in the operation.

The term “mobile information terminal” refers to a portable computing device able to receive, process, and display information, such as a wearable display, tablet computer, or mobile phone.

The term “visual display device” refers to hardware capable of presenting information visually to a user, including but not limited to wearable displays, head-mounted displays, or handheld screens.

The term “change information of on-site status” refers to data indicating updates or alterations in real-time conditions at the worksite, including changes in worker attendance, item arrivals, process status, or equipment functionality.

The term “operational input” refers to instructions, confirmations, feedback, or other direct data entries provided by users in the course of operation.

The term “dynamic schedule update” refers to the process of automatically modifying an existing work schedule in response to detected changes or inputs, to maintain or improve operational efficiency.

The term “emotion estimation processing” refers to computational analysis and inference of a user's emotional state using sensory data such as images, audio, physiological metrics, or interaction patterns.

The term “assignment adjustment” refers to the modification of worker-task allocations in a work schedule based on new information or inferred parameters, such as user emotion or feedback.

The term “display method adjustment” refers to changing the way information is presented to the user based on contextual variables, such as emotional state or role.

The term “feedback information” refers to data generated or provided by users, sensors, or processes that indicate progress, status, or issues encountered during task execution, which can be used to further refine system operations.

The term “work progress” refers to the advancement, completion status, or timeline of tasks assigned to one or more workers in an operational workflow.

The term “user operation” refers to any action, command, or input performed by a user on the system interface or device in the course of using the system.

One embodiment of the present invention can be implemented in the context of a logistics management system designed to generate and update optimized work schedules by utilizing a generative artificial intelligence model.

A server is equipped with a processor, memory, communication interfaces, and is connected to one or more databases. The server may use general-purpose computer hardware and common database systems such as a relational database (for example, PostgreSQL or MySQL). The server executes software written in a high-level programming language, such as Python, which is responsible for obtaining and processing operational data.

The server acquires worker attribute information, task history information, and item attribute information from the database. For example, worker attribute information may include skill levels, certifications, shift schedules, and recent performance. Task history information may describe previously assigned tasks and their outcomes, while item attribute information may describe the types, quantities, identifiers, and locations of goods handled at the logistics facility. The server performs data consistency checking, such as verifying the existence and correctness of each record, and performs pre-processing, including data cleaning, normalization, and formatting.

Once data preparation is complete, the server generates a prompt sentence that summarizes the operational status and requirements. This prompt is constructed in natural language or a structured template in text format, appropriate for input to a generative artificial intelligence model. The server invokes the model, which may be implemented using software such as a large language model API or a custom deep learning framework. An example of such a prompt sentence is:

“Based on the following worker skills, current assignments, and the list of incoming and outgoing items, generate an optimized work schedule for this shift, balancing workload and taking product priorities into account.”

The generative artificial intelligence model analyzes the inputs and synthesizes an optimized work schedule, specifying task assignments, timing, and priorities for each worker or terminal involved in operations.

The server transmits the generated schedule to mobile information terminals operated by users, such as wearable display devices (including general-purpose smart glasses or head-mounted displays). These terminals execute an application developed using platform-specific software development kits to receive, process, and visually present scheduling information. The visual display device on the terminal shows assigned tasks, times, responsible workers, and other relevant details in an interactive user interface.

Terminals may further acquire real-time information via embedded sensors, such as radio-frequency identification (RFID) readers, barcode scanners, cameras, and microphones, or by processing user inputs such as voice commands and gestures. When a change in on-site status or an operational input is detected, the terminal transmits this information back to the server. The server updates the operational database as necessary and can execute a new prompt to the generative artificial intelligence model, regenerating and distributing an updated schedule to all relevant terminals.

Additionally, the server may estimate a user's emotional state by analyzing image or audio data captured from the terminal's camera or microphone. Emotion estimation can be implemented using machine learning models or cloud-based emotion recognition services. If, for example, a user is detected as fatigued or stressed, this information is included as a variable in the next generated prompt. The interface presentation on the terminal can be adjusted, such as increasing font size, minimizing displayed information, or delivering supportive instructions.

During operations, a user can confirm task receipt, report progress, request assistance, or provide other feedback through the terminal interface. The server receives such feedback, incorporates it into operational data, and may use it to further refine schedules or adjust subsequent prompt sentences.

A further example of a prompt sentence generated by the server is:

“Given that worker A appears fatigued based on recent operation and current workload, please generate a schedule in which this worker is assigned only light tasks for the next two hours, while ensuring all shipment deadlines are met.”

Through this configuration, the system offers a highly adaptable logistics solution, making real-time, person-centered schedule adjustments according to both operational variables and user states.

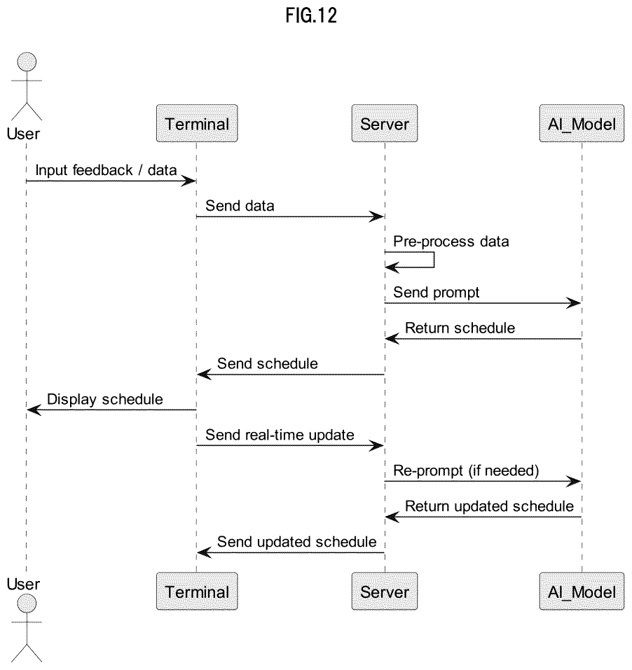

The following describes the processing flow using FIG. 12.

### Step 1

The server acquires worker attribute information, task history information, and item attribute information from the operational database as input. The server performs data consistency checking and pre-processing, such as removing duplicated records, filling missing values, and normalizing data formats. As output, the server generates a set of cleaned and formatted data ready for scheduling.

### Step 2

The server generates a prompt sentence using the cleaned and formatted data as input. The prompt sentence combines information about current worker skills, workstation assignments, and pending tasks in natural language text. As output, the server produces a textual prompt ready for input to a generative AI model.

### Step 3

The server sends the prompt sentence to the generative AI model as input. The generative AI model analyzes the provided information to perform optimization calculations regarding task allocation, workload balance, and shift scheduling. The output from the generative AI model is a set of optimized work schedules that specify task assignments, timings, and responsible workers.

### Step 4

The server transmits the optimized work schedule data to the terminal. The terminal, using an installed application, receives the scheduling data as input, and parses it to present worker task assignments interactively on a visual user interface. The terminal highlights each task's details, such as start time, location, and priority. The output is a visual task schedule displayed to the user on a wearable display device.

### Step 5

The terminal monitors real-time on-site changes and user operational input, such as sensor data indicating worker presence, scanned item barcodes, or manual user feedback. Any detected event, such as worker absence or new shipment arrival, is captured as input and sent to the server. As output, the terminal provides real-time status updates for further processing.

### Step 6

The server receives on-site status updates and operational input from the terminal as input data. The server updates the operational database accordingly and, if significant changes are detected, re-initiates Step 2 to generate a new prompt for the generative AI model. The output is a dynamically updated work schedule reflecting the latest on-site situation.

### Step 7

The terminal collects user feedback and emotional indicators, such as voice tone or facial expression data. These data are input for emotion estimation processing on the server. The server uses these signals to infer the user's emotional state and may adjust the content or presentation of the work schedule, such as simplifying instructions if the user is estimated to be stressed. The output is an adaptively modified task schedule presentation on the user's terminal.

### Step 8

The user reviews the displayed work schedule and either confirms task receipt, performs assigned operations, or provides further feedback through the terminal interface. The input is the user's response or comments entered through the device, and the output is confirmation or feedback data sent to the server for ongoing refining of the scheduling process.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In conventional work management systems, it is difficult to effectively balance operational efficiency with the mental well-being of workers. Specifically, previous systems lack mechanisms to dynamically generate and update work schedules in real-time based on sudden operational changes and do not adequately account for the user's psychological state in the scheduling and presentation process. As a result, there is a limitation in both the flexibility of operation and reduction of psychological stress for users.

The specific processing by the specific processing unit 290 of the data processing device 12 in Example 2 is realized by the following means.

The present invention provides a server comprising a processor configured to acquire operation-related information and article-related information, analyze a user's psychological state using audio and image input devices, generate and update an optimal work schedule through a generative information processing model based on the collected data, and present the schedule using a display device with an interface dynamically adapted to the user's psychological state. This enables real-time optimization of work schedules considering both operational efficiency and user mental health, as well as adaptive user interfaces that help reduce psychological burden and improve flexibility in business operations.

The term “operation-related information” refers to data indicating the progress, responsibility, and content of tasks performed during business operations.

The term “article-related information” refers to data describing attributes, classifications, or other details about items managed within business operations.

The term “generative information processing model” refers to an artificial intelligence model that generates optimized plans or schedules based on given input data.

The term “work schedule” refers to a plan that specifies tasks to be performed, the order of execution, responsible individuals, and timing within operational processes.

The term “psychological state” refers to an evaluation or assessment of a user's mental or emotional condition, such as stress, fatigue, or calmness.

The term “audio input device” refers to hardware capable of capturing sound waves, such as a microphone, for use in analyzing spoken user input or vocal tone.

The term “image input device” refers to hardware capable of capturing visual information, such as a camera, for use in analyzing user facial expressions or other visual cues.

The term “display device” refers to a hardware component, such as a screen or monitor, that provides visual output to the user.

The term “presentation format” refers to the manner or style in which information, such as a work schedule, is visually or audibly presented to the user.

The term “operation history information” refers to records or logs of previous instances of business tasks, including outcomes and associated contextual data.

The term “workforce resources” refers to available personnel and their associated capabilities, schedules, or availability within an organization.

The term “real-time” refers to processing or updates occurring during or nearly simultaneously with ongoing operations or changes in the system.

The server acquires operation-related information and article-related information by connecting to one or more databases. These databases may store records such as employee skills, shift histories, task assignments, and product attributes. As potential software to access and process these records, the server uses a relational database management system such as a general-purpose SQL database and a data processing environment such as Python combined with the Pandas library. The server fills any missing information and standardizes data formats for further processing.

The terminal, which can include a personal computer, tablet, or other smart device equipped with a camera and microphone, collects real-time data on the user's psychological state. Specifically, the terminal records audio through a microphone and video from a camera whenever the user logs in or interacts with the interface. To analyze the facial expression and voice features, the terminal can operate emotion analysis software such as OpenFace for facial emotion recognition and an audio analysis library such as pyAudioAnalysis. The terminal thereby produces a psychological assessment result (such as “calm”, “stressed”, or “fatigued”), which is transmitted to the server together with the operation and article information.

The server is further configured to generate and update an optimal work schedule based on the collected data. For this, the server utilizes a generative AI model, such as a general-purpose language model or an AI scheduling framework capable of processing prompt-based instructions and multi-modal data. The data and analysis results, including the user's current psychological state, are formatted into a suitable input for the AI model. The server then constructs a prompt sentence and calls the AI model's API endpoint. For example, the following prompt sentence can be used:

“Please generate an optimal logistics work schedule that increases operational efficiency while reducing user psychological burden. Take into account worker skill levels, shift information, product types, and real-time user emotion data such as stress or fatigue status.”

The generative AI model responds with a proposed work schedule, which may specify task assignments, time slots, and personnel distribution, all adjusted for efficiency and user well-being.

The terminal receives the schedule data and displays the work schedule to the user. The presentation format of the schedule is dynamically adjusted according to the user's current psychological state. For example, if the server has determined that the user is showing signs of stress, the terminal renders a simplified interface, highlights immediate tasks only, and utilizes calming visuals and supportive messages.

The user interacts with the presented schedule via the terminal—such as acknowledging tasks, indicating completion, or reporting unexpected issues by touch input or voice. The terminal continually monitors for real-time feedback or situational changes and transmits any updated information to the server.

The server processes these updates, and if needed, repeats the schedule generation process to maintain an optimal allocation of tasks and resources. All actions and data exchanges are logged in the database for traceability and future analysis.

Through the use of a generative AI model, prompt sentences, emotion-detection hardware and software, and dynamically adaptive user interfaces, this system enables real-time, efficient, and human-centric work schedule management.

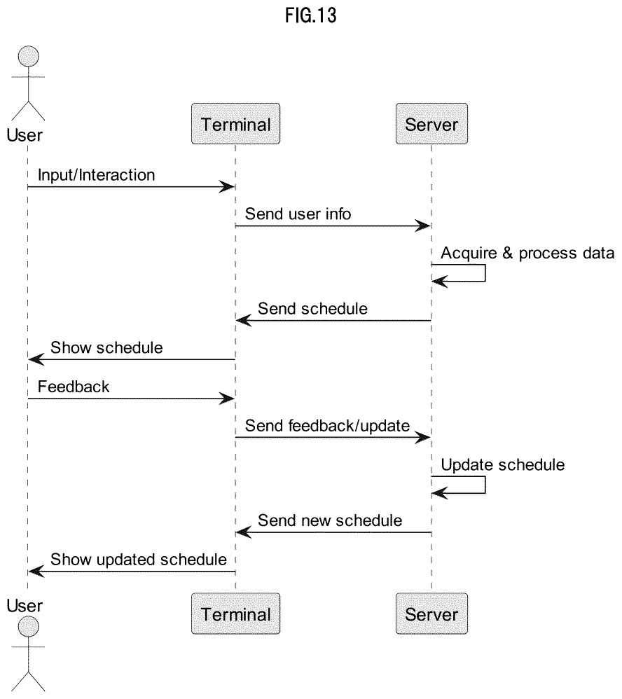

The following describes the processing flow using FIG. 13.

### Step 1

The server accesses one or more databases to acquire operation-related information and article-related information. The input includes database records such as employee skill levels, shift histories, and product attributes. The server processes these inputs by extracting relevant fields using SQL queries and applies data cleaning steps, such as filling in missing values and standardizing the format. The output is a structured dataset containing all necessary operational and product information in a unified format.

### Step 2

The terminal collects real-time data about the user's psychological state. The input consists of audio data from a microphone and video data from a camera. The terminal processes these inputs by running facial expression analysis with emotion recognition software and voice analysis with an audio analysis library. The output is a set of psychological assessment labels (for example, “calm”, “stressed”, or “fatigued”), which are then formatted as part of the user profile.

### Step 3

The server receives the structured operational data, article data, and user psychological assessment. The input includes all these data elements, combined into a single dataset. The server formats this information into a prompt sentence for the generative AI model and submits it via an API call. The server processes the AI model's response, which is an optimized work schedule tailored to efficiency and user well-being. The output of this step is the generated work schedule.

### Step 4

The terminal presents the generated work schedule to the user through a display interface. The input is the work schedule data and the user's psychological assessment. The terminal determines the appropriate presentation format based on the user's current state, for example by simplifying the interface or emphasizing supportive messages if the user is stressed. The terminal then visually or audibly presents the work schedule to the user. The output is the user's access to the task schedule in a dynamically adapted interface.

### Step 5

The user interacts with the terminal to acknowledge the schedule, report task completion, or notify the system of unexpected events or delays. The input consists of the user's interactions through the terminal interface —-touch input, buttons, or speech. The terminal processes these inputs, packages the relevant updates, and sends them to the server. The output is a real-time update stream reflecting any changes or feedback from the user.

### Step 6

The server monitors and processes real-time updates received from the terminal. The input includes all user feedback, schedule changes, and operational events. Based on these inputs, the server determines whether a new optimized schedule needs to be generated. If so, the server repeats the steps of data preparation and AI prompt submission, continually updating the schedule as necessary. The output is a revised work schedule distributed back to the terminal.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional logistics operations management, optimizing work schedules in real time is challenging, particularly when considering the psychological state and emotional well-being of workers. Existing systems lack the ability to dynamically adjust work schedules and their display formats based on each worker's current mental and emotional condition, which can result in increased stress, decreased productivity, and suboptimal workflow efficiency. Furthermore, there is a deficiency in seamlessly managing real-time changes arising from operational updates or human factors, as well as in utilizing advanced artificial intelligence to generate and adjust work schedules accordingly.

The specific processing by the specific processing unit 290 of the data processing device 12 in Application Example 2 is realized by the following means.

The present invention provides a server comprising a processor that: acquires work information and product information; inputs the acquired information together with a predetermined prompt sentence into a generative AI model to generate an optimized work schedule; analyzes a user's psychological state using emotion recognition technology; dynamically adjusts the display method of the work schedule according to the user's psychological state; presents the adjusted work schedule to a user terminal as a visual field display using a display device; and detects and automatically updates the work schedule in response to real-time changes in the work situation and in the user's psychological state. This enables efficient, adaptive, and user-centric management of logistics and operational schedules, improves worker well-being, and optimizes workflow in real time.

The term “work information” refers to data related to the progress, assignment, and content of tasks performed in an operational setting.

The term “product information” refers to data regarding items managed within a logistics or operational system, including identification, quantity, source or destination, and storage location.

The term “generative AI model” refers to an artificial intelligence model capable of producing outputs such as optimized schedules or plans based on input data and a provided prompt sentence, utilizing machine learning algorithms.

The term “prompt sentence” refers to a predetermined input instruction or query that guides the generative AI model in generating appropriate outputs.

The term “emotion recognition technology” refers to a computational method for analyzing and determining a user's psychological or emotional state based on data such as facial expressions, voice tone, or behavioral patterns.

The term “work schedule” refers to a structured plan or timetable outlining tasks, assignments, and timing for operational activities.

The term “display method” refers to the manner or format in which information, such as a work schedule, is visually presented to a user, which may vary dynamically according to certain conditions.

The term “user terminal” refers to a computing device, such as a smart device or wearable equipment, used by an operator to receive and interact with system outputs.

The term “visual field display” refers to the presentation of information within the user's line of sight, typically using a device such as a head-mounted display or smart glasses.

The term “real-time” refers to operations or processes that are executed and updated immediately or with minimal delay as events occur.

The term “work situation” refers to the current status, progress, or conditions of ongoing operations and tasks within the system.

The term “psychological state” refers to the current mental or emotional status of a user, including factors such as fatigue, stress, or motivation.

One embodiment of the invention will now be described in detail based on the above claims.

The system comprises a server, a user terminal, and a display device. The server includes a processor, system memory, network interfaces, and data storage. The processor is configured to acquire work information and product information from at least one database, which may be implemented using a relational database management system such as MySQL or a document database such as MongoDB.

The server processes the acquired data by converting and normalizing it into a predetermined format, such as JSON, using software frameworks like Python with pandas or similar data processing tools. The server then constructs a prompt sentence based on the operational context. For example, the prompt sentence may be:

“Based on the following work and product data, and considering user emotions, create an optimized logistics work schedule.”

The server inputs the formatted work information and product information, together with the constructed prompt sentence, into a generative AI model. The generative AI model may be implemented using a general-purpose language model based on machine learning, such as a model running on TensorFlow, PyTorch, or using an external AI API service. The AI model generates an optimized work schedule, taking into account factors such as worker allocation, task priority, and operational deadlines.

In parallel, the user terminal, which may be a wearable computer such as smart glasses or a smart device, periodically captures sensory data from the user. The terminal collects data on the user's facial expressions using an integrated camera and captures speech using a built-in microphone. These data are securely transmitted to the server for further processing.

The server analyzes the received sensory data using emotion recognition technology. This analysis may be performed by employing software libraries such as OpenCV for facial expression recognition and cloud-based or local speech analysis tools for voice tone evaluation. The server estimates the psychological state of the user, identifying conditions such as fatigue, stress, or calmness.

Based on the analyzed psychological state, the server dynamically adjusts the display method for the work schedule. For example, if the user is identified as fatigued, the server may simplify the content displayed, reducing the number of tasks shown or using calming color schemes. The adjusted work schedule and display instructions are then transmitted from the server to the user terminal.

The user terminal, such as smart glasses or a heads-up display, renders the received schedule information within the user's visual field. The terminal automatically applies the display adjustments specified by the server, ensuring that the user receives the most relevant and least burdensome information according to their current state.

The user interacts with the displayed information to perform logistics tasks, and the terminal continues to monitor the user's emotional and operational status. Changes in the work situation or user emotions are detected in real time, prompting the server to automatically update and re-issue the optimized schedule and display configuration as necessary.

For instance, in a warehouse environment during a high-demand period, the server collects newly added task data and current worker status, generates a prompt such as “Please generate an optimal work schedule for the current logistics tasks, considering the psychological state and emotional feedback of the user,” and produces an updated schedule. If the server determines the user has become stressed, the system minimizes displayed tasks until recovery is detected.

This embodiment enables highly adaptive, user-focused, and efficient operation within a logistics context, providing real-time optimization and supporting worker well-being through AI-driven scheduling and emotion-adaptive user interfaces.

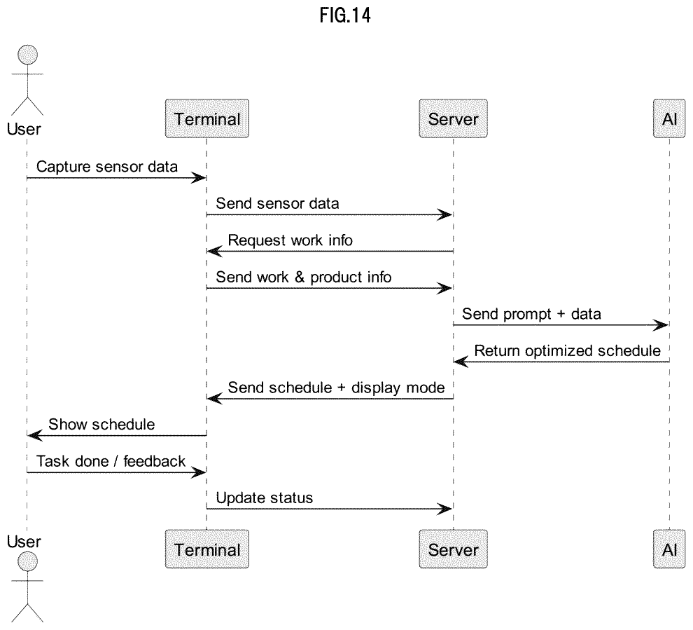

The following describes the processing flow using FIG. 14.

### Step 1

The server acquires work information and product information from a database. The input for this step consists of raw data stored in the database regarding ongoing tasks, worker assignments, product locations, and inventory quantities. The server processes this input by querying the database and formatting the data into a standardized structure, such as a JSON object. The output is the formatted work and product data ready for further processing.

### Step 2

The server constructs a prompt sentence based on the current operational context. The input is the formatted work and product data obtained in Step 1 and predefined templates for prompt generation. The server incorporates the data into the prompt sentence, such as “Based on the following work and product data, and considering user emotions, create an optimized logistics work schedule.” The output is a prompt sentence containing embedded work and product information.

### Step 3

The server inputs the prompt sentence, along with the work and product data, into a generative AI model. The input is the constructed prompt sentence and formatted data. The server processes these inputs by sending them to the generative AI system, which may be implemented as a local or cloud-based AI service. The AI model analyzes the input and outputs an optimized work schedule in a structured format, such as a list of tasks with assignments and timelines.

### Step 4

The user terminal captures real-time sensory data from the user, including facial images and audio recordings. The input for this step is the live video and audio data collected through integrated cameras and microphones in the terminal. The terminal uploads this sensory data to the server for analysis. The output is a stream of user sensory data sent to the server.

### Step 5

The server receives the sensory data and performs emotion recognition analysis. The input is the recorded facial images and audio data from the user terminal. The server processes this input using emotion recognition technologies, such as computer vision and speech analysis tools, to assess the user's psychological state (for example, detecting fatigue or stress). The output is a classification of the user's current psychological state.

### Step 6

The server dynamically adjusts the display method for the work schedule based on the user's psychological state. The input is the optimized work schedule from Step 3 and the emotion classification from Step 5. The server processes these inputs by modifying the schedule's display properties—such as simplifying the layout and highlighting breaks—if the user is found to be fatigued. The output is an adjusted work schedule with specific display instructions.

### Step 7

The user terminal receives the adjusted work schedule and display instructions from the server. The input for this step consists of the layout-adjusted schedule and the associated instructions. The terminal renders the received schedule within the user's visual field, modifying the visual display according to the server's guidance (e.g., showing only urgent tasks in large, clear text). The output is a real-time augmented reality display visible to the user.

### Step 8

The user interacts with the schedule display and performs assigned work tasks. The input for this step is the real-time displayed schedule in the user's field of vision. The user refers to the visual cues, completes tasks, and continues with their work activities. The output is operational progress and updates to the task status, which may trigger new data collection and updates throughout the system.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

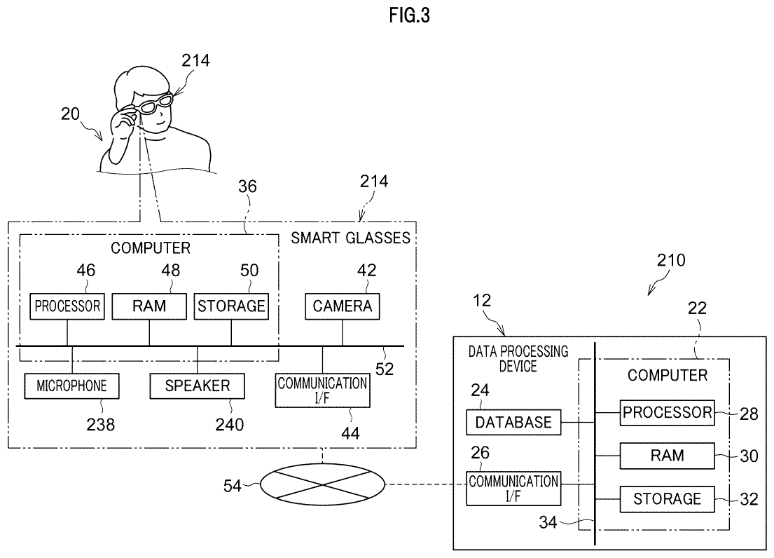

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

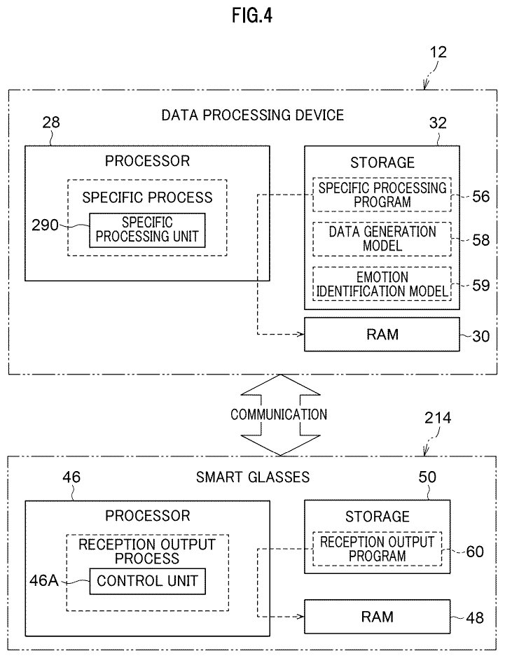

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

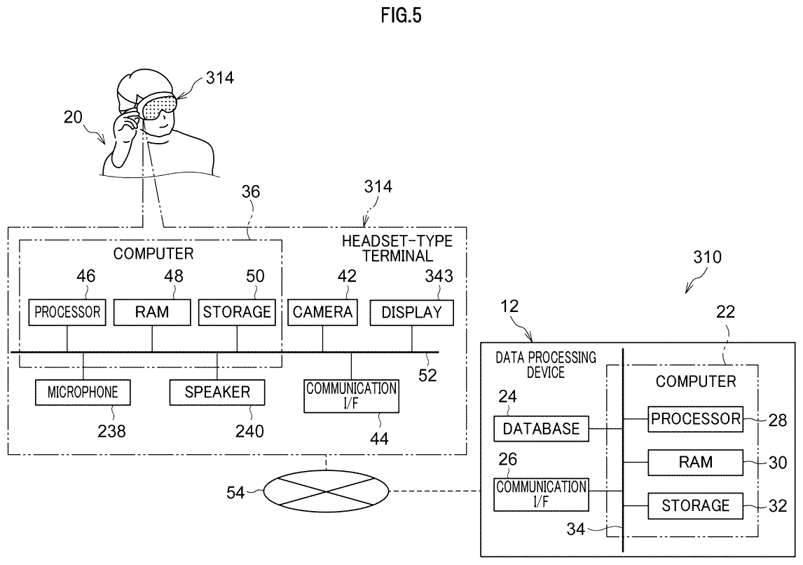

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

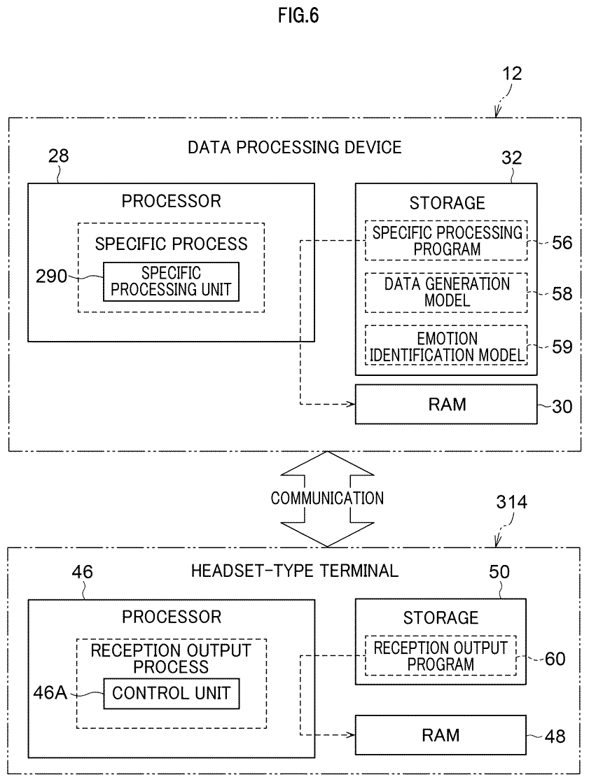

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

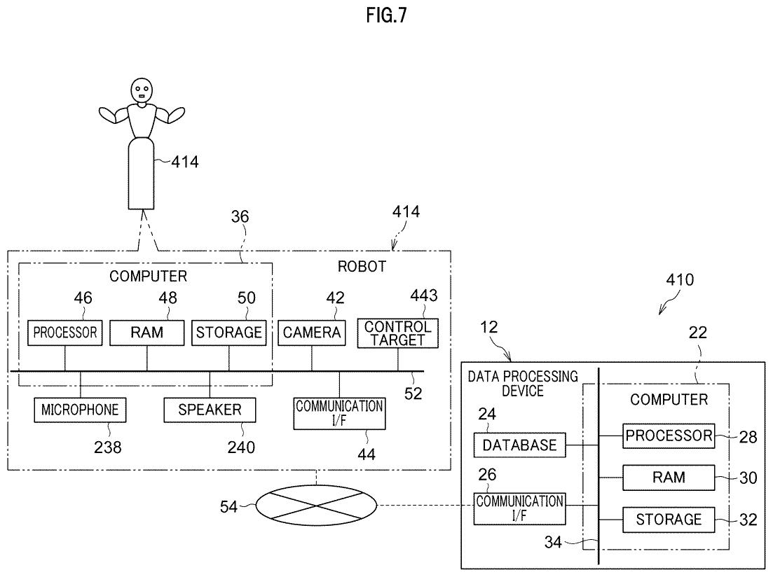

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

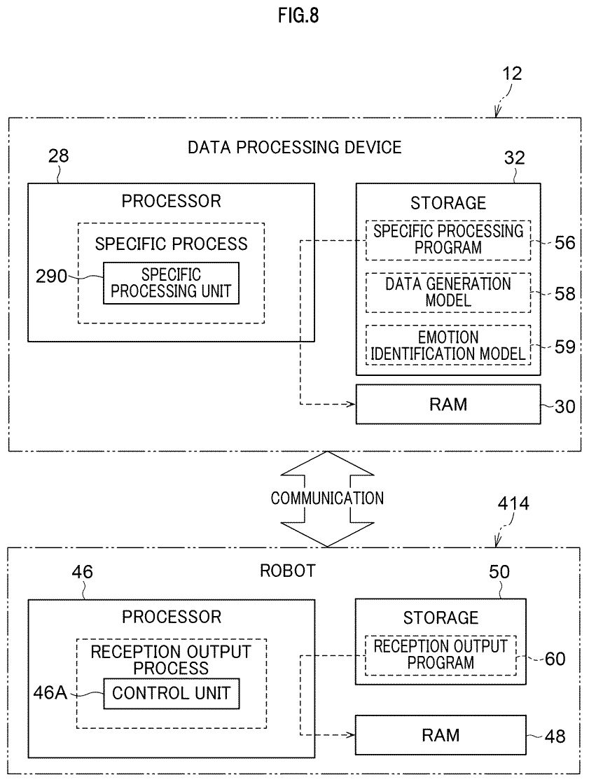

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naive Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

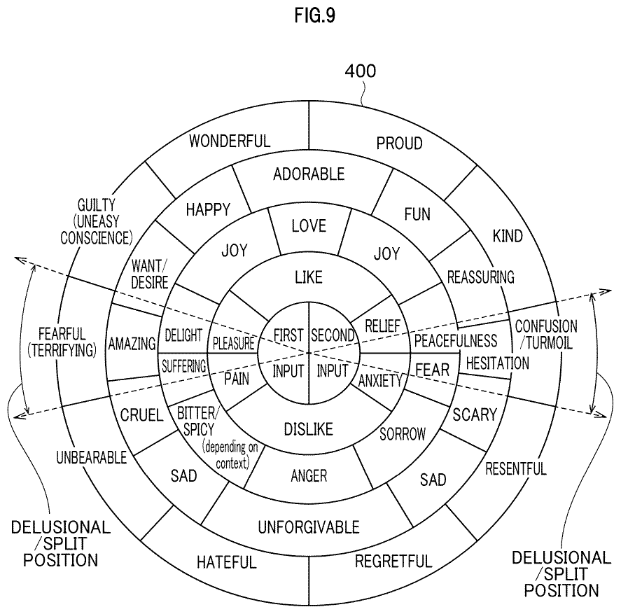

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

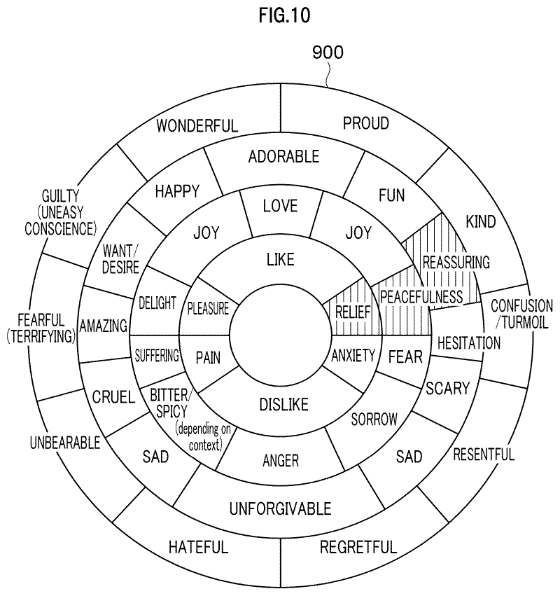

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
collect operation-related information and item-related information from an information storage device and perform integrity verification and outlier removal processing on the collected information,
generate, based on the cleansed information, a prompt sentence dynamically for input to a generative artificial intelligence model to automatically produce optimized operation schedule information,
output the generated operation schedule information as an interactive display screen on an information display device,
and detect status changes in real time based on monitoring information input from an operation environment, and to automatically update the operation schedule information by inputting a new prompt sentence to the generative artificial intelligence model.

### Supplementary 2

The system according to supplementary 1,
wherein the processor is configured to
predict future demand and supply of labor resources.

### Supplementary 3

The system according to supplementary 1,
wherein the processor is configured to
analyze operational performance data stored previously and execute an optimization process for improving work efficiency.

### Application Example 1

### Supplementary 1

A system comprising a processor,
wherein the processor is configured to
acquire worker attribute information, task history information, and item attribute information, and perform data consistency checking and pre-processing of information,
generate a prompt sentence based on the acquired information and input said prompt sentence to a generative artificial intelligence model to automatically generate an optimized work schedule,
display the generated work schedule interactively on a mobile information terminal equipped with a visual display device,
acquire change information of on-site status or operational input in real time and dynamically update the work schedule,
estimate a user's emotional state using emotion estimation processing,
adaptively adjust the assignment of the work schedule or display method of information based on the emotion estimation result,
acquire feedback information based on work progress or user operation and reflect such information in the generation and presentation method of the schedule.

### Supplementary 2

The system according to supplementary 1,
wherein the processor is configured to predict future workload and personnel allocation.

### Supplementary 3

The system according to supplementary 1,
wherein the processor is configured to analyze past work record information and extract information that contributes to the optimization of work processes or personnel assignment.

### Example 2

### Supplementary 1

A system comprising a processor,
wherein the processor is configured to
acquire information relating to operations and information relating to articles,
generate an optimal work schedule by inputting the acquired information and information indicating a user's psychological state into a generative information processing model,
present the generated work schedule to a user using a display device for interaction between the user and an information processing apparatus, with the presentation format adjusted according to the user's psychological state,
analyze the user's psychological state by using an audio input device and an image input device and dynamically adjust the presentation method of the work schedule based on the analysis result, and
detect information updates in real-time and update the work schedule by using the generative information processing model.

### Supplementary 2

The system according to supplementary 1,
wherein the processor is configured to
predict a demand and supply of workforce resources for a predetermined period.

### Supplementary 3

The system according to supplementary 1,
wherein the processor is configured to
analyze past operation history information and improve the efficiency of the work schedule.

### Application Example 2

### Supplementary 1

A system comprising a processor,
wherein the processor is configured to
acquire work information and product information,
input the work information and the product information together with a predetermined prompt sentence into a generative AI model to generate an optimized work schedule,
analyze a user's psychological state using emotion recognition technology,
dynamically adjust a display method of the work schedule according to the user's psychological state,
present the adjusted work schedule to a user terminal as a visual field display using a display device, and
detect changes in the work situation and the user's psychological state in real time and automatically update the work schedule.

### Supplementary 2

The system according to supplementary 1,
wherein the processor is configured to
predict a future supply and demand of workforce.

### Supplementary 3

The system according to supplementary 1,
wherein the processor is configured to
analyze past work performance information to improve operational efficiency.

What is claimed is:

1. A system comprising a processor,
the processor being configured to:
retrieve work information and product information;
generate an optimized work schedule using a generative AI;
display the generated work schedule on a user terminal;
detect changes in real time; and
update the work schedule.

2. The system according to claim 1, wherein the processor is further configured to predict future labor demand and supply.

3. The system according to claim 1, wherein the processor is further configured to analyze past performance data to improve operational efficiency.
